(19) United States
(12) Patent Application Publication
(10) Pub. No.: US 2025/0062806 A1
(43) Pub. Date: Feb. 20, 2025

(54) RESOURCE ALLOCATION FOR BACKSCATTER DEVICES IN THE SPARSE CHANNEL USING SYMBIOTIC RADIO

(71) Applicant: ISTANBUL MEDIPOL UNIVERSITESI, Istanbul (TR)

(72) Inventors: Muhammad Bilal JANJUA, Istanbul (TR); Hüseyin ARSLAN, Istanbul (TR); Saira RAFIQUE, Istanbul (TR)

(21) Appl. No.: 18/719,713

(22) PCT Filed: Dec. 8, 2022
(86) PCT No.: PCT/TR2022/051449

§ 371 Date: Jun. 13, 2024

(30) Foreign Application Priority Data
Dec. 14, 2021 (TR) TR 2021/019879

(51) Int. Cl. H04B 7/06; H04W 52/42

(52) U.S. Cl. CPC H04B 7/0617; H04B 7/0695; H04W 52/42

(57) ABSTRACT

Disclosed is a method for allocating resources for the low power backscatter devices in a sparse environment with a beamspace channel model in a symbiotic radio system. In other words, the method provides an adaptive power allocation mechanism to enhance the power of the beams incident on the backscatter devices for signal detection at the receiver in the beamspace channel model.

### TECHNICAL FIELD

In the conventional communication system, at higher frequencies more antennas are deployed at the transmitter for beamforming and beamspace channel model is used for the characterization of channel sparsity. This channel model selects the beams with the strongest gains and suppresses other beams with weak channel gain. In this case, if the backscatter devices are served by the low power beams, they cannot be visualised in the beamspace channel representation.

This invention relates to a method for allocating resource for the low power backscatter devices in a sparse environment with beamspace channel model in symbiotic radio system. In other words, present invention provides an adaptive power allocation mechanism to enhance the power of the beams incident on the backscatter devices for signal detection at the receiver in beamspace channel model.

### PRIOR ART

Wireless connectivity is an essential requirement of IoT devices to share information and to transfer data to the cloud. Conventionally, these devices are energy-constrained and low data rate and are expected to operate for a longer period. However, active signal transmission for communication consumes a significant amount of power and reduces battery life.

Backscatter communication has been proposed as a potential candidate to solve this issue, which consumes very less amount of power than the conventional wireless systems proposed for IoT e.g., long-range radio access (LoRA), narrowband IoT (NB-IOT), Bluetooth low energy (BLE).

Despite the energy benefits, backscatter devices provide limited data rate of mega-bits-per-second (Mbps) at very short distances, which maybe sufficient for current IoT applications occupancy and temperature monitoring etc., however, it will not be sufficient for future IoT applications such as augmented brain implanted devices with many probes, reality (AR)/virtual reality (VR) and other data hungry and energy limited devices. Therefore, a milimeter wave (mmWave) tag (i.e. backscatter device) has been proposed that can operate on mmWave frequencies e.g., 24 GHz to achieve high data rates of giga-bits. However, mmWave with multiple input multiple output (MIMO) antenna systems require accurate channel estimation for high capacity gains, that is challenging due to high complexity issues. To solve this problem, low complex channel estimation techniques based on beamspace channel model are developed, which select the beams with high gains while suppressing the low gain beams. Although these techniques provide the high gains for mmWave MIMO systems in conventional communication, these are not suitable for cooperative ambient backscatter communication systems (also termed as symbiotic radio systems), where backscatter devices (i.e. mmWave Tag) utilize the beam signals in the air to transmit their data to joint receiver (i.e., a receiver that receives its data from a base station and also collects the data of IoT devices with backscatter communication). In this case, new techniques should be designed to incorporate backscatter devices into beamspace channel model to avoid the suppression of backscatter devices signals while suprressing the low gain beams.

There are few approaches in the literature that studied the backscatter communication in the mmWave MIMO systems. In a publication by Mazaheri M. H., et al, published in 2020 in Proceedings of the 19th ACM Workshop on Hot Topics in Networks the authors designed a mmWave tag to enable a high data rate backscatter communication system. In this work, it was considered that the monostatic system to enable backscatter communication in the mmWave spectrum and designed a backscatter tag operating at mmWave frequencies. In another work by Chae, Y., et al, published in 2020 in Proceedings of the 14th International Workshop on Wireless Network Testbeds, Experimental evaluation & Characterization, authors propose a bistatic mmWave backscatter system using IEEE 802.11 ad 60 GHz commercial system. In this work a bistatic backscatter communication is proposed for mmWave backscatter communication, where the tags are used to perform beamsearching and blockage detection.

When the prior art solutions are evaluated some problems arise for example the work by Mazaheri M. H., et al designed a mmWave tag enabling high data rate backscatter communication but they considered only the monostatic configuration of backscatter system. In the work by Chae, Y., et al, a bi-static mmWave backscatter system using IEEE 802.11 ad 60GHz commercial system is proposed and they did not exploit received beamforming for the optimization of backscatter communication network.

In the current solutions, mmWave tags are designed to enable backscatter communication; however, these solutions are not pratical for beam space channel model based sparse mmWave systems. Because in these systems only beams with high gains are considered for communication neglecting the potential presence of low power backscatter devices in the network

### Aim of the Invention

Applications of IoT are spreading enormously in health, agriculture, transportation, industrial automation, remote monitoring, etc. Usually, IoT devices and sensors are used to collect and transfer data and are expected to operate for a longer period. There are some other IoT applications which requires very high data rate with very low power such as augmented reality (AR) and brain implanted devices with thousands of probes etc. Although ambient backscatter communication provides a low power communication these are not suitable for high data rate IoT applications. Therefore, an ambient backscatter communication system is required that can use high frequency such as mmWave signals in the environment to provide high data rates with very low power. To develop such a system, two of the critical challenges are the resource allocation to backscatter devices and signal detection at the receiver in a sparse mmWave environment. The purpose of the invention are as follows
1. To enable high data rate and low power communication for IoT applications for healthcare, autonomous vehicles and industrial automation through ambient backscatter communication in the sparse mmWave environment.
2. Design a symbiotic radio system for the cooperation between ambient backscatter communication system and mmWave based primary communication systems.
3. Increasing the gains of beams in the direction of backscatter devices to enable their detection at the receiver that perform beamspace channel model for channel estimation.

### BRIEF DESCRIPTION OF THE INVENTION

The invention relates to a symbiotic radio system, which allows cooperation between the primary system (i.e. a conventional wireless communiction system operating at mmWave frequencies e.g., WiFi, Cellular) and the backscatter communication system. In the symbiotic radio, both the primary and backscatter communication systems not only share the signals but also share the infrastructure e.g., transmitter and receiver.

The invention also relates to a resource allocation method for backscatter devices under the sparse environment in the symbiotic radio system disclosed in the invention.

The invention further relates to a symbiotic radio system employing the resource allocation method of the invention.

The symbiotic radio system of the invention enables high throughput, low power backscatter communication in the sparse millimeter wave environment.

It is possible to prepare a cooperative symbiotic radio system with a joint transmitter and receiver for the backscatter communication and primary communication system. Unlike the aforementioned methods, the proposed symbiotic system supports the ambient backscatter communication.

Also, with the method of the invention it is possible to ensure that the backscatter devices are served with appropriate power levels, thus optimal resource allocation is also provided through the proposed method.

The invention disclosed the resource allocation to the backscatter communiction devices in the sparse environment with symbiotic radio. In mmWave MIMO system, beamspace channel model is used for channel estimation with low complexity, which selects the beam with high gains and supress the beams with low gains. Considering a symbiotic radio system where both the backscatter devices and mmWave system shares the same receiver, the backscatter devices signal maybe suppressed with low beam gains. To solve this problem, this invention disclosed the adaptive power allocation to enhance gains of the beams in the direction of backscatter devices so when the beamspace channel model is applied these beams do not suppress and the backscatter devices' signal can be detected at the receiver.

Backscatter communication has been considered as a potential candidate to provide low power and high data rate communication compared to active communication systems and conventional backscatter communication sytems, respectively, particularly for loT devices. Additionally, the research on ambient backscatter system based mmWave systems is still at its early stage.

The advantages and unique elements of the invention are as follows:
1. A symbiotic radio system for cooperative communication between mmWave systems and ambient backscatter communication systems.
2. Resource allocation to the backscatter devices in mmWave MIMO sparse environment.
3. Adaptive power allocation to increase the gains of beams in the direction of backscatter device for signal detection at receiver that performs channel estimation using beamspace channel model.

### EXPLANATION OF FIGURES

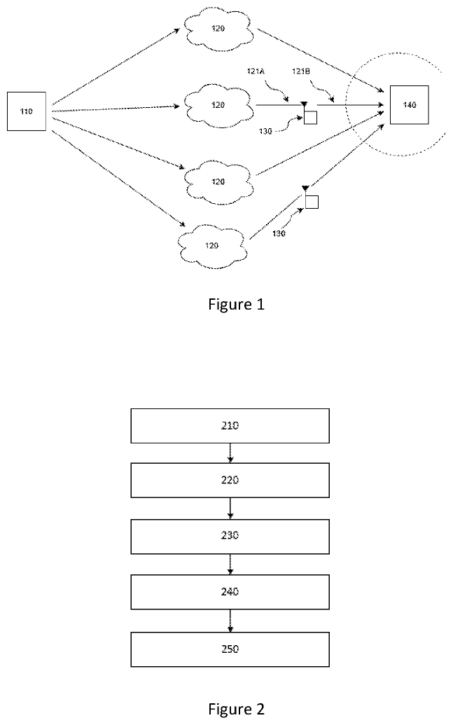

FIG. 1: Scheme illustrating the system model of the resource allocation method for backscatter devices under the sparse environment in the symbiotic radio system
110: transmission point
120: scattering clusters
121A: Forward scattered beam
121B: Backscattered beams
130: backscatter devices
140: receiver

FIG. 2: a flow diagram illustrating the steps of the resource allocation method according to the invention
210: This step represents the tracking process in which the beam sweeping is performed to find the best angles and the gains of beams at the receiver 140 with and without backscatter devices
220: This step represents the beam transmission at 110 towards the receiver 140, which also supports the backscatter communication
230: This step represents the data modulation at the backscatter devices 130
240: This step represents the beamspace channel model application at the receiver 140
250: This step represents the adaptive power allocation mechanism for the backscatter devices which have incident beams with low gains and suppressed in the beamspace channel model at 140.

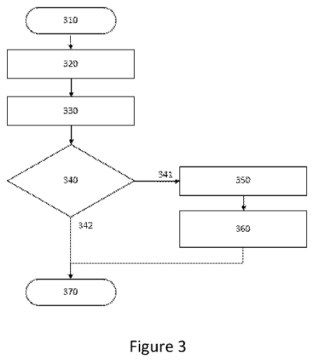

FIG. 3: flow chart illustrating the adaptive power allocation mechanism disclosed in the inventions to support backscatter communication in the symbiotic radio systems.
310: start the flow chart.
320: Applying the beamspace channel at 140 and detecting the signals of backscatter devices.
330: Backscatter device signal detection
340: Check if all the backscatter devices' signals are detected?

341: No
342: Yes
350: Finding the angles and gains of the backscatter devices which are not detected at 140 and giving feedback to 110
360: increasing the signal power of beams directed toward non-detected backscatter devices.
370: End of the flow chart

### DETAILED DESCRIPTION OF THE INVENTION

Present invention relates to a symbiotic radio system comprising;
A transmission point (110) equipped with multiple antennas and is transmitting beams via digital beamforming towards the scattering clusters (120),
A receiver (140) receiving the spread beams from the scattering clusters and the backscatter devices (130)
Characterized in that
backscatter devices (130) modulate and backscatter the incident beams to transmit their data to the receiver (130), which jointly receives the backscattered beams (121B) along with its own signal beams and
an adaptive power allocation mechanism is used at transmission point (110) to incorporate the backscatter devices in the beamspace channel model.

The present invention relates to a resource allocation method for backscatter devices under the sparse environment in the symbiotic radio system, wherein said method comprises of the steps;
Determination of the gains of the beams in defined angular dimensions by the receiver (140) while all the backscatter devices (130) are in the non-reflecting mode, then turning on each backscatter device (130) one by one and determination of the angles and gains related to the backscatter devices, (201)
Transmitting the beams at the transmission point (110) towards the receiver (140), (202)
Performing data modulation at the backscatter devices (130), preferably by switching the antenna in reflecting and non-reflecting states, (230)
Applying beamspace channel model at the receiver (140), (240)
Applying adaptive power allocation method for backscatter devices (130) which have incident beams with low gains and suppressed in the beamspace channel model at the receiver (140), (250)

Herein, in step 210, it is assumed that these backscatter devices (130) provide significant processing gains at the receiver (140) so that they can be distinguishably determined and localized.

In another aspect, present invention relates to an adaptive power allocation method to support backscatter communication in the symbiotic radio systems, wherein said method comprises the steps of;
Applying the beamspace channel at the receiver (140) and detecting the signals of backscatter devices (130), (320)
Checking is all the backscatter devices' signals are detected
If all the backscatter devices' signals are detected then the method is finalized
If all the backscatter devices' signals are not detected then the angles and gains of the backscatter devices which are not detected at the receiver (140) are found and feedback to the transmission point (110), (350)
Increasing the signal power of beams directed toward non-detected backscatter devices until all the backscatter devices achieve detectable signal power and then the method is finalized.

### Industrial Applicability of the Invention

The invention is a novel method to support high data rate backscatter communiction in mmWave MIMO systems. This is very critical for the industry which is related to critical IoT devices and sensors applications.

Overall, any wireless communication technology can utilize this invention for backscatter signal transmission and/or reception. However, standards like 3GPP-based cellular, IEEE 802.11 based LAN standards, IEEE 802.15 based wireless personal area network standards, RFID related standards (e.g., ISO/IEC, ASTM) are particularly relevant due to the support of backscatter communication in one way or the other. Furthermore, the proposed technique in the invention can be implemented on any device, system, or network capable of supporting any of the aforementioned standards.

Around these basic concepts, it is possible to develop several embodiments regarding the subject matter of the invention; therefore, the invention cannot be limited to the examples disclosed herein, and the invention is essentially as defined in the claims.

It is obvious that a person skilled in the art can convey the novelty of the invention using similar embodiments and/or that such embodiments can be applied to other fields similar to those used in the related art. Therefore, it is also obvious that these kinds of embodiments are void of the novelty criteria and the criteria of exceeding the known state of the art.

Detailed explanation of the figures:

FIG. 1 is illustrating the system model of the resource allocation method for backscatter devices under the sparse environment in the symbiotic radio system disclosed in the invention. A transmission point 110 equipped with multiple antennas is transmitting beams via digital beamforming towards the scattering clusters 120. The receiver 140 receives the spread beams from the scattering clusters and the backscatter devices 130. It is worth mentioning that backscatter devices 130 modulate and backscatter the incident beams to transmit their data to the receiver 130, which jointly receives the backscattered beams 121B along with its own signal beams. Besides, at the receiver 140, the beamspace channel model is applied to select the beams with the strongest gains and suppress the weak gains to improve the performance and reduce the processing. However, the application of beamspace channel model may result in the suppression of the beams that are reflected by the backscatter devices due to their weak gains. To incorporate the backscatter devices in the beamspace channel model adaptive power allocation mechanism is used at 110 to increase the gains of the beams in the direction of backscatter devices and hence these backscatter devices' appearance in the beamspace channel model.

FIG. 2 is a flow diagram illustrating the steps of the resource allocation method disclosed in the invention.

Step 210 presents the tracking process in which the beam sweeping is performed to find the best angles and the gains of beams at the receiver 140 with and without backscatter devices. Initially, all the backscatter devices are in non-reflecting mode and receiver 110 finds the gains of the beams in the defined angular dimensions. Afterward, each backscatter device is turned on one by one and the receiver 140 finds the angles and gains related to the backscatter devices. It is assumed that these backscatter devices provide significant processing gains at the receiver so that they can be distinguished determined and localized.

Step 220 presents the transmission of the beam at 110 towards the receiver 140, which also supports the backscatter communication.

Step 230 presents the data modulation at the backscatter devices 130, one way to do that is by switching the antenna in reflecting and non-reflecting states.

Step 240 presents the beamspace channel model application at the receiver 140.

Step 250 presents the adaptive power allocation mechanism for the backscatter devices which have incident beams with low gains and are suppressed in the beamspace channel model at 140

FIG. 3 is a flow chart illustrating the adaptive power allocation mechanism disclosed in the inventions to support backscatter communication in symbiotic radio systems. Step 310 presents the start of the flow chart.

Step 320, apply the beamspace channel at 140 and detect the signals of backscatter devices.

Step 330, if all the backscatter devices' signals are detected? is no 341 go to Step 350. Otherwise, if all the backscatter devices' signals are detected? is yes 342 go to Step 370.

Step 350, find the angles and gains of the backscatter devices which are not detected at 140 and feedback to 110.

Step 360, increase the signal power of beams directed toward non-detected backscatter devices.

Step 370, End flowchart

In addition to the disclosed adaptive power allocation mechanism, adaptive beamforming, cluster selection, and component selection mechanism etc., may also be considered for resource allocation and detection of backscatter devices' signals at 140 in symbiotic radio systems.

Also, herein some definitions of the terms used in the present application are given.

Backscatter communication is a way of communication in which the transmitter modulates and backscatter the signal transmitted by the transmission point to transmit its information to the receiver.

Ambient backscatter communication is a type of backscatter communication in which the backscatter device utilizes the signals of ambient sources e.g., WiFi access point, TV tower, cellular base station, etc

Symbiotic radio is a type of radio system in which two or more radio systems have mutual coexistence to support each other.

Internet of things (IOT) is a network of devices that are connected to other devices through the internet to collect and share data about the environment or the way they are used.

1. A symbiotic radio system comprising;;
a transmission point equipped with multiple antennas and is transmitting beams via digital beamforming towards scattering clusters,
a receiver receives the spread beams from the scattering clusters and backscatter devices,
wherein the backscatter devices modulate and backscatter the incident beams to transmit their data to the receiver, which jointly receives the backscattered beams along with its own signal beams, and
applying adaptive power allocation method for backscatter devices which have incident beams with low gains and suppressed in the beamspace channel model at the receiver.

2. A resource allocation method for backscatter devices under the sparse environment in the symbiotic radio system according to claim 1, wherein said method comprises the steps of:
determination of the gains of the beams in defined angular dimensions by the receiver while all the backscatter devices are in the non-reflecting mode, then turning on each backscatter device one by one and determination of the angles and gains related to the backscatter devices,
transmitting the beams at a transmission point towards the receiver,
performing data modulation at the backscatter devices, preferably by switching the antenna in reflecting and non-reflecting states,
applying beamspace channel model at the receiver, and
applying adaptive power allocation method for backscatter devices which have incident beams with low gains and suppressed in the beamspace channel model at the receiver.

3. A resource allocation method according to claim 1, wherein the adaptive power allocation method comprises the steps of:
applying the beamspace channel at the receiver and detecting the signals of backscatter devices,
checking if all the backscatter devices' signals are detected,
if all the backscatter devices' signals are detected then the method is finalized,
If all the backscatter devices' signals are not detected then the angles and gains of the backscatter devices which are not detected at the receiver are found and feedback to the transmission point, and
increasing the signal power of beams directed toward non-detected backscatter devices until all the backscatter devices achieve detectable signal power and then the method is finalized.
